(19) United States
(12) Patent Application Publication
(10) Pub. No.: US 2012/0034825 A1
(43) Pub. Date: Feb. 9, 2012

(54) CONNECTION TERMINAL FOR HIGH-VOLTAGE CABLE

(76) Inventors: Ye YUAN, Shenzhen (CN); Bing Zhao, Shenzhen (CN)

(21) Appl. No.: 13/277,415

(22) Filed: Oct. 20, 2011

Related U.S. Application Data
(63) Continuation of application No. PCT/CN2010/072219, filed on Apr. 26, 2010.

(30) Foreign Application Priority Data
Apr. 30, 2009 (CN) 200920131244.8

(51) Int. Cl. H01R 4/70

(52) U.S. Cl. 439/730

(57) ABSTRACT

The present invention discloses a connection terminal of a high-voltage cable comprising a connector; a cable having a conductive core and an insulating layer surrounding the conductive core, with the conductive core being coupled to a free end of the connector; a first plastic layer surrounding at least a part of the free end of the connector and at least a part of the insulating layer; and a second plastic layer surrounding at least a part of the first plastic layer and at least a part of the free end of the connector.

### CROSS-REFERENCE TO RELATED APPLICATION

This application is a continuation of International Application No. PCT/CN2010/072219, filed Apr. 26, 2010, designating the United States of America, which claims priority to Chinese Patent Application No. 200920131244.8, filed on Apr. 30, 2009 to State Intellectual Property Office, PRC, the entire contents of both of which are incorporated herein by reference.

### FIELD OF THE INVENTION

The present invention relates to a terminal, more particularly to a connection terminal of a high-voltage cable.

### BACKGROUND OF THE INVENTION

At present, high-voltage terminals have been widely used and developed, especially on pure electric or hybrid vehicle systems. The difference of a pure electric or hybrid vehicle from a traditional fuel vehicle lies in that the pure electric or hybrid vehicle needs high-voltage cables to transmit high-current and high-voltage power. Waterproof insulation of the high-voltage terminal has been a difficult problem for the manufacturers.

### SUMMARY OF THE INVENTION

The present disclosure is provided to solve at least one problem as mentioned above. Accordingly, a connection terminal of a high-voltage cable is provided, which can overcome the problem of high cost and low quality in the art. Furthermore, the insulating and waterproof performance can be greatly enhanced.

According to an aspect of the disclosure, a connection terminal of a high-voltage cable is provided. The connection terminal may comprise a connector having a connecting end and a free end connected with the connecting end; a cable having a conductive core and an insulating layer surrounding the conductive core. The conductive core may be coupled to the free end of the connector. The connection terminal may further comprise: a first plastic layer surrounding at least a part of the free end of the connector and at least a part of the insulating layer; and a second plastic layer surrounding at least a part of the first plastic layer and at least a part of the free end of the connector.

According to an embodiment of the disclosure, the second plastic layer may be formed with at least a groove or at least a protrusion on an outer surface of the second plastic layer where the first and second surrounding layers are overlap with each other.

According to another embodiment of the disclosure, the entire connector is covered by the second plastic layer with the connecting end exposed to the outside.

According to another embodiment of the present disclosure, a pair of plastic layers are formed at the connecting portion between the insulating layer of the cable and the connector. Waterproof and insulation properties will be thus enhanced largely, which not only reduces the manufacturing cost but also increases high temperature resistance and high pressure resistance.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

### BRIEF DESCRIPTION OF THE DRAWINGS

The aforementioned features and advantages of the invention as well as additional features and advantages thereof will be more clearly understood hereinafter as a result of a detailed description of embodiments when taken in conjunction with the drawings, in which:

FIG. 1 shows a schematic view of a connection terminal according to an embodiment of the disclosure;

FIG. 2 shows a cross sectional view of FIG. 1;

FIGS. 3A and 3B show an enlarged view of a portion A indicated in FIG. 2 respectively; and

FIGS. 4A and 4B show an enlarged view of a portion B indicated in FIG. 2 respectively.

### DETAILED DESCRIPTION OF THE EMBODIMENTS

It will be appreciated by those of ordinary skill in the art that the present disclosure can be embodied in other specific forms without departing from the spirit or essential characters thereof. The presently disclosed embodiments are therefore considered in all respects to be illustrative and not restrictive.

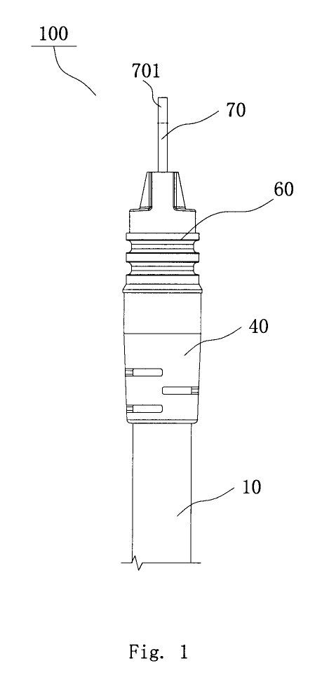

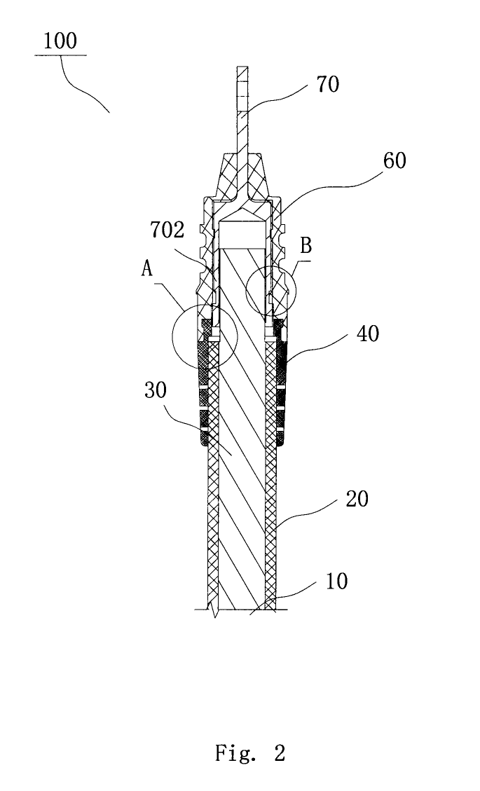

One embodiment of the present disclosure discloses a connection terminal 100 of a high-voltage cable as shown in FIGS. 1 and 2, which comprises a connector 70, a cable 10 having a conductive core 30 and an insulating layer 20 surrounding the conductive core 30. The connector 70 may have a connecting end 701 and a free end 702 connected therewith. As shown in FIG. 1, the connector 70 is coupled to the conductive core 30, and a first plastic layer 40 and a second plastic layer 60 surround the cable 10 to seal the connector 70 and the insulating layer 20. The first plastic layer 40 surrounds at least a part of the free end 702 of the connector 70 and at least a part of the insulating layer 20. The second plastic layer 60 surrounds at least a part of the first plastic layer 40 and at least a part of the free end 702 of the connector 70.

The conductive core 30 may be coupled to the connector 70, and the connector 70 may be connected to a working device (not shown). Then the cable 10 can transmit current or voltage signal to the working device via the conductive core 30 and the connector 70.

In one embodiment, the free end 702 may have a hollow chamber 703. The conductive core 30 can be placed or inserted therein directly. During assembling, the conductive core 30 may be pressed fit into the hollow chamber 703, so that there is a tight and reliable connection between the connector 70 and the cable 10.

To ensure the connection terminal is waterproof and insulating, the first plastic layer 40 is formed to surround at least a part of the free end 702 of the connector 70 and at least a part of the insulating layer 20, as shown in FIG. 2. The first plastic layer 40 may be injection molded onto the connector 70 and the insulating layer 20. Then, the second plastic layer 60 may be formed to surround at least a part of the first plastic layer 40 and at least a part of the free end 702 of the connector 70. As shown in FIG. 2, the entire connector 70 may be covered by the second plastic layer 60 with the connecting end 701 exposed to the outside.

The manufacturing method may be described as follows. In one embodiment, the second plastic layer 60 has an injection molding temperature higher than that of the first plastic layer 40. That is to say, a first insulating material having a lower injection molding temperature is used to form the first plastic layer 40, for instance, the first insulating material having a lower injection molding temperature of about 120° C. to about 160° C. Then a second insulating material having a higher injection molding temperature is used to form the second plastic layer 60, for instance, the second insulating material having a higher injection molding temperature of about 160° C. to about 220° C.

To enhance the binding force between the plastic layer 40 and 60, the connected connector 70 and cable 10, mating features may be formed on the connector 70, the first plastic layer 40 and/or the second plastic layer 60.

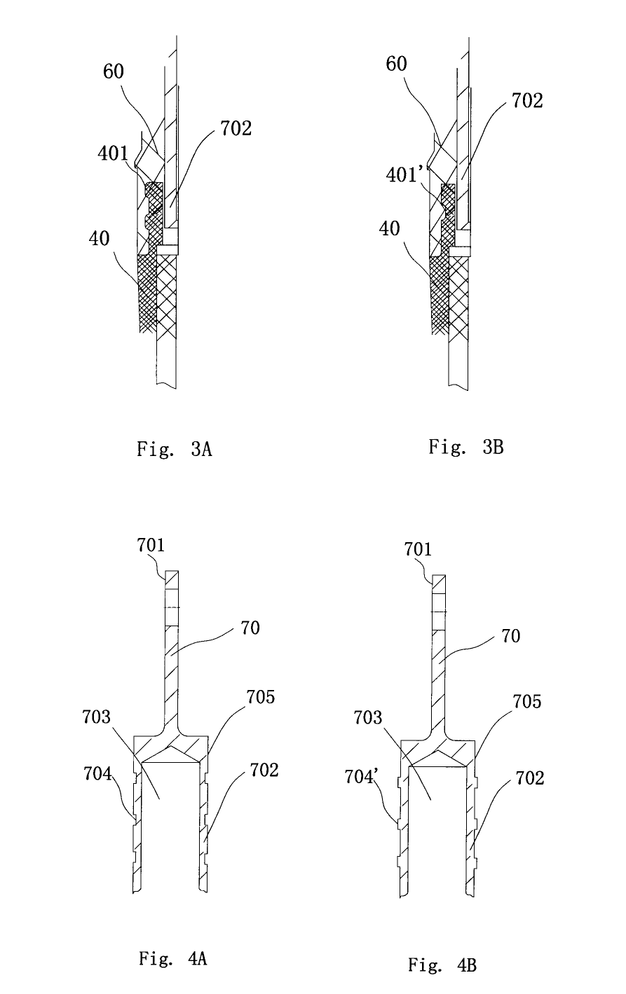

FIGS. 3A and 3B show an enlarged view of a portion A indicated in FIG. 2 respectively. And FIGS. 4A and 4B show an enlarged view of a portion B indicated in FIG. 2 respectively, showing the mating structures.

As shown in FIG. 3A, the first plastic layer 40 is formed with at least a protrusion 401 (such as two shown in FIG. 3A), so that when the second plastic layer 60 is formed, such as by injection molding, onto the first plastic layer 40, the melt second plastic material of the second plastic layer 60 is bound tightly onto the first plastic layer 40, thus further enhancing the reliability of the connection terminal 100.

According to another embodiment of the disclosure, the first plastic layer 40 may be further formed with at least a groove 401′ (such as one shown in FIG. 3B), so that when the second plastic layer 60 is formed, such as by injection molding, onto the first plastic layer 40, the melt second plastic material of the second plastic layer 60 is bound tightly onto the first plastic layer 40, thus further enhancing the reliability of the connection terminal 100.

Alternatively, to enhance the binding force between the connector 70 and the second plastic layer 60, an outer surface 705 of the free end 702 of the connector 70 is formed with at least a groove or at least a protrusion. In FIG. 4A, three grooves 704 are formed on the outer surface 705, so that when the second plastic layer 60 is formed, such as by injection molding, onto the free end 702, the melt second plastic material of the second plastic layer 60 is bound tightly onto the connector 70, thus further enhancing the reliability of the connection terminal 100. According to another embodiment of the disclosure, three grooves 704′ are formed on the outer surface 705, which may also enhance the reliability of the connection terminal 100.

The thickness and length of the plastic layers 40 and 60 may be designed according to practical requirements, such as according to the current or voltage to be transmitted by the cable 10.

In some embodiments of the disclosure, the first plastic layer 40 may be made of insulating materials, such as PVC (polyvinyl chloride) or TPU (thermoplastic polyurethane). The second plastic layer 60 may be made of insulating materials, such as PA (Polyamide) or PBT (Polybutylene terephthalate).

Although the present disclosure have been described in detail with reference to several embodiments, additional variations and modifications exist within the scope and spirit as described and defined in the following claims.

What is claimed is:

1. A connection terminal of a high-voltage cable comprising:
a connector having a connecting end and a free end connected with the connecting end;
a cable having a conductive core and an insulating layer surrounding the conductive core, with the conductive core being coupled to the free end of the connector;
a first plastic layer surrounding at least a part of the free end of the connector and at least a part of the insulating layer; and
a second plastic layer surrounding at least a part of the first plastic layer and at least a part of the free end of the connector.

2. The connection terminal according to claim 1, wherein the free end of the connector has a hollow chamber with the conductive core being inserted therein.

3. The connection terminal according to claim 1, wherein the entire connector is covered by the second plastic layer with the connecting end exposed to the outside.

4. The connection terminal according to claim 1, wherein the second plastic layer is formed with at least a groove or at least a protrusion on an outer surface of the second plastic layer where the first and second plastic layers are overlap with each other.

5. The connection terminal according to claim 1, wherein an outer surface of the free end of the connector is formed with at least a groove or at least a protrusion where the connector is surrounded by the second plastic layer.

6. The connection terminal according to claim 1, wherein the second plastic layer has an injection molding temperature higher than that of the first plastic layer.

7. The connection terminal according to claim 6, wherein the first plastic layer is made of a first insulating material having an injection molding temperature of about 120° C. to about 160° C.

8. The connection terminal according to claim 7, wherein the second plastic layer is made of a second insulating material having an injection molding temperature of about 160° C. to about 220° C.

9. The connection terminal according to claim 7, wherein the first insulating material is polyvinyl chloride or thermoplastic polyurethane.

10. The connection terminal according to claim 8, wherein the second insulating material is polyamide or polybutylene terephthalate.
